(19) United States
(12) Patent Application Publication
(10) Pub. No.: US 2007/0274389 A1
(43) Pub. Date: Nov. 29, 2007

(54) Method and apparatus for encoding/decoding interlaced video signal using different types of information of lower layer

(75) Inventors: So-young Kim, Seoul (KR); Kyo-hyuk Lee, Yongin-si (KR); Woo-jin Han, Suwon-si (KR); Tammy Lee, Seoul (KR); Manu Mathew, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/708,630

(22) Filed: Feb. 21, 2007

Related U.S. Application Data
(60) Provisional application No. 60/775,342, filed on Feb. 22, 2006.
(60) Provisional application No. 60/787,520, filed on Mar. 31, 2006.
(60) Provisional application No. 60/787,495, filed on Mar. 31, 2006.

(30) Foreign Application Priority Data
Jun. 13, 2006 (KR) 10-2006-0053130

(51) Int. Cl. H04N 11/04

(52) U.S. Cl. 375/240.16; 375/E07.026

(57) ABSTRACT

A method and apparatus for encoding/decoding a multi-layer interlaced video signal having macroblocks coded in an interlaced manner is provided. The method includes determining whether a pair of macroblocks of a current layer are of a frame type and a corresponding pair of macroblocks of a lower layer are of a field type; and predicting and encoding a macroblock of the current layer by interpolating information of the top or bottom field of a corresponding macroblock of the lower layer, if the pair of the macroblocks of the current layer are of the frame type and the corresponding pair of the macroblocks of the lower layer are of the field type, and the top and bottom fields of the corresponding pair of the macroblocks of the lower layer have been coded in different prediction modes.

### CROSS-REFERENCE TO RELATED APPLICATIONS

This application claims priority from U.S. Provisional Patent Application Nos. 60/775,342, 60/787,520, 60/787,495, filed on Feb. 22, 2006, Mar. 31, 2006 and Mar. 31, 2006, respectively in the United States Patent and Trademark Office, and Korean Patent Application No. 10-2006-0053130 filed on Jun. 13, 2006 in the Korean Intellectual Property Office, the disclosures of which are incorporated herein by reference in their entirety.

### BACKGROUND OF THE INVENTION

1. Field of the Invention

Methods and apparatuses consistent with the present invention relate to encoding/decoding a video signal, and more particularly, to encoding/decoding an interlaced video signal using different types of information of a lower layer.

2. Description of the Related Art

Interlaced field scanning was introduced as analog video compression technology. Although progressive scanning provides better digital compression and image quality, the use of interlaced field scanning has persisted in many related art imaging apparatuses. Interlaced field scanning refers to dividing a plurality of rows that form a screen into even-numbered rows and odd-numbered rows, separately transmitting data, and individually scanning the even-numbered rows and the odd-numbered rows.

FIG. 1 is a diagram comparing a related art progressive frame with interlaced fields. Referring to FIG. 1, a progressive frame 111 includes all image information in a screen. A top field 112 is obtained after even-numbered fields are extracted from the progressive frame 110. A bottom field 114 is obtained after odd-numbered fields are extracted from the progressive frame 111. A progressive frame is divided into two interlaced fields, and the reproduction time of the interlaced fields is set to less than a predetermined period of time.

As interlaced field scanning is applied to video coding, it has been required to change prediction and compensation processes of progressive scanning.

In particular, unlike in progressive scanning, in interlaced field scanning, it is difficult to perform motion prediction since information regarding an adjacent pixel or region belongs to a different field. Therefore, a motion prediction process suitable for interlaced field scanning is needed.

### SUMMARY OF THE INVENTION

The present invention provides a method and apparatus for performing motion prediction in interlaced video encoding and decoding.

However, the aspects of the present invention are not restricted to those set forth herein. The above and other aspects of the present invention will become more apparent to one of daily skill in the art to which the present invention pertains by referencing a detailed description of the present invention given below.

According to an aspect of the present invention, there is provided a method of encoding a multi-layer interlaced video signal including macroblocks that were coded in an interlaced manner. The method includes determining whether a pair of macroblocks of a current layer are of a frame type and a corresponding pair of macroblocks of a lower layer are of a field type, and determining whether top and bottom fields of the corresponding pair of the macroblocks of the lower layer have been coded in different prediction modes; and predicting and encoding a macroblock of the current layer by interpolating information of the top or bottom field of a corresponding macroblock of the lower layer, if the pair of the macroblocks of the current layer are of the frame type and the corresponding pair of macroblocks of the lower layer are of the field type, and the top and bottom fields of the corresponding pair of the macroblocks of the lower layer have been coded in different prediction modes.

According to another aspect of the present invention, there is provided a method of decoding a multi-layer interlaced video signal including macroblocks that were coded in an interlaced manner. The method includes determining whether a pair of macroblocks of a current layer are of a frame type and a corresponding pair of macroblocks of a lower layer are of a field type, and determining whether top and bottom fields of the corresponding pair of the macroblocks of the lower layer have been coded in different prediction modes; and predicting and decoding the macroblock of the current layer by interpolating information of the top or bottom field of a corresponding macroblock of the lower layer, if the pair of the macroblocks of the current layer are of the frame type and the corresponding pair of macroblocks of the lower layer are of the field type, and the top and bottom fields of the corresponding pair of the macroblocks of the lower layer have been coded in different prediction modes.

According to another aspect of the present invention, there is provided a method of encoding a multi-layer interlaced video signal including macroblocks that were coded in an interlaced manner. The method includes determining whether a pair of macroblocks of a current layer are of a field type and a corresponding pair of macroblocks of a lower layer are of a frame type, and determining whether top and bottom macroblocks constituting the corresponding pair of the macroblocks of the lower layer have been coded in different prediction modes; and encoding an inter macroblock of the current layer with reference to a sub-block of a frame-type inter macroblock of the lower layer, if the pair of the macroblocks of the current layer are of the field type and the corresponding pair of the macroblocks of the lower layer are of the frame type, and the top and bottom macroblocks constituting the corresponding pair of the macroblocks of the lower layer have been coded in different prediction modes.

According to another aspect of the present invention, there is provided a method of decoding a multi-layer interlaced video signal including macroblocks that were coded in an interlaced manner. The method includes determining whether a pair of macroblocks of a current layer are of a field type and a corresponding pair of macroblocks of a lower layer are of a frame type, and determining whether top and bottom macroblocks constituting the corresponding pair of the macroblocks of the lower layer have been coded in different prediction modes; and decoding an inter macroblock of the current layer with reference to a sub-block of a frame-type inter macroblock of the lower layer, if the pair of the macroblocks of the current layer are of the field type and the corresponding pair of the macroblocks of the lower layer are of the frame type, and the top and bottom macroblocks constituting the corresponding pair of the macroblocks of the lower layer have been coded in different prediction modes.

According to another aspect of the present invention, there is provided a method of encoding a multi-layer interlaced video signal including macroblocks that were coded in an interlaced manner. The method includes determining whether a pair of macroblocks of a current layer are of a field type and a corresponding pair of macroblocks of a lower layer are of a frame type; setting a reference index of a macroblock of the current layer to twice a reference index of a corresponding macroblock of the lower layer, if the pair of the macroblocks of the current layer are of the field type and the corresponding pair of the macroblocks of the lower layer are of the frame type; and encoding the macroblock of the current layer using the set reference index.

According to another aspect of the present invention, there is provided a method of decoding a multi-layer interlaced video signal including macroblocks that were coded in an interlaced manner. The method includes determining whether a pair of macroblocks of a current layer are of a field type and a corresponding pair of macroblocks of a lower layer are of a frame type; setting a reference index of a macroblock of the current layer to twice a reference index of a corresponding macroblock of the lower layer, if the pair of the macroblocks of the current layer are of the field type and the corresponding pair of the macroblocks of the lower layer are of the frame type; and decoding the macroblock of the current layer using the set reference index.

According to another aspect of the present invention, there is provided a method of encoding a multi-layer interlaced video signal including macroblocks that were coded in an interlaced manner. The method includes determining whether a pair of macroblocks of a current layer are of a field type and a corresponding pair of macroblocks of a lower layer are of a frame type; and enlarging a pixel of a top block in a first field of a macroblock of the current layer by setting the enlarged pixel as a pixel value of a bottom block in the field of the macroblock, and encoding the macroblock of the current layer, if the pair of the macroblocks of the current layer are of the field type, and the corresponding pair of the macroblocks of the lower layer are of the frame type.

According to another aspect of the present invention, there is provided a method of decoding a multi-layer interlaced video signal including macroblocks that were coded in an interlaced manner. The method includes determining whether a pair of macroblocks of a current layer are of a field type and a corresponding pair of macroblocks of a lower layer are of a frame type; and enlarging a pixel of a top block in a first field of a macroblock in the current layer by setting the enlarged pixel as a pixel value of a bottom block in the field of the macroblock, and decoding the macroblock of the current layer, if the pair of the macroblocks of the current layer are of the field type and the corresponding pair of the macroblock of the lower layer are of the frame type.

According to another aspect of the present invention, there is provided an apparatus for encoding a multi-layer interlaced video signal including macroblocks that were coded in an interlaced manner. The apparatus includes a field/frame conversion unit which determines whether a pair of macroblocks of a current layer are of a frame type and a corresponding pair of macroblocks of a lower layer are of a field type, and determines whether top and bottom fields of the corresponding pair of the macroblocks of the lower layer have been coded in different prediction modes, and which interpolates information of the top or bottom field of a macroblock of the lower layer in order to predict a corresponding macroblock of the current layer, if the pair of the macroblocks of the current layer are of the frame type and the corresponding pair of the macroblocks of the lower layer are of the field type, and the top and bottom fields of the corresponding pair of the macroblocks of the lower layer have been coded in different prediction modes; and a prediction encoding unit which encodes the corresponding macroblock of the current layer based on a result of the prediction.

According to another aspect of the present invention, there is provided an apparatus for decoding a multi-layer interlaced video signal including macroblocks that were coded in an interlaced manner. The apparatus includes a field/frame conversion unit which determines whether a pair of macroblocks of a current layer are of a frame type and a corresponding pair of macroblocks of a lower layer are of a field type, and determines whether top and bottom fields of the corresponding pair of the macroblocks of the lower layer have been coded in different prediction modes, and which interpolates information of the top or bottom field of a macroblock of the lower layer in order to predict a corresponding macroblock of the current layer, if the pair of the macroblocks of the current layer are of the frame type and the corresponding pair of the macroblock of the lower layer are of the field type, and the top and bottom fields of the corresponding pair of the macroblocks of the lower layer have been coded in different prediction modes; and a prediction decoding unit which decodes the corresponding macroblock of the current layer based on a result of the prediction.

According to another aspect of the present invention, there is provided an apparatus for encoding a multi-layer interlaced video signal including macroblocks that were coded in an interlaced manner. The apparatus includes a field/frame conversion unit which determines whether a pair of macroblocks of a current layer are of a field type and a corresponding pair of macroblocks of a lower layer are of a frame type, and determines whether top and bottom macroblocks constituting the corresponding pair of the macroblocks of the lower layer have been coded in different prediction modes, and which refers to a sub-block of a frame-type inter macroblock of the lower layer in order to predict an inter macroblock of the current layer, if the pair of the macroblocks of the current layer are of the field type and the corresponding pair of the macroblocks of the lower layer are of the frame type, and the top and bottom macroblocks constituting the corresponding pair of the macroblocks of the lower layer have been coded in different prediction modes; and a prediction encoding unit which encodes the inter macroblock of the current layer using a result of the prediction.

According to another aspect of the present invention, there is provided an apparatus for decoding a multi-layer interlaced video signal including macroblocks that were coded in an interlaced manner. The apparatus includes a field/frame conversion unit which determines whether a pair of macroblocks of a current layer are of a frame type and a corresponding pair of macroblocks of a lower layer are of a field type, and determines whether top and bottom macroblocks constituting the corresponding pair of the macroblocks of the lower layer have been coded in different prediction modes, and which refers to a sub-block of a frame-type inter macroblock of the lower layer in order to predict an inter macroblock of the current layer, if the pair of the macroblocks of the current layer are of the field type and the corresponding pair of macroblocks of the lower layer are of the frame type, and the top and bottom macroblocks constituting the corresponding pair of the macroblocks of the lower layer have been coded in different prediction modes; and a prediction decoding unit which decodes the inter macroblock of the current layer using a result of the prediction.

According to another aspect of the present invention, there is provided an apparatus for encoding a multi-layer interlaced video signal including macroblocks that were coded in an interlaced manner. The apparatus includes a field/frame conversion unit which determines whether a pair of macroblocks of a current layer are of a field type and a corresponding pair of macroblocks of a lower layer are of a frame type, and sets a reference index of a macroblock of the current layer to twice a reference index of a corresponding macroblock of the lower layer, if the pair of the macroblocks of the current layer are of the field type and the corresponding pair of the macroblocks of the lower layer are of the frame type; and a prediction encoding unit which encodes the macroblock of the current layer using the set reference index.

According to another aspect of the present invention, there is provided an apparatus for decoding a multi-layer interlaced video signal including macroblocks that were coded in an interlaced manner. The apparatus includes a field/frame conversion unit which determines whether a pair of macroblocks of a current layer are of a field type and a corresponding pair of macroblocks of a lower layer are of a frame type, and sets a reference index of a macroblock of the current layer to twice a reference index of a corresponding macroblock of the lower layer, if the pair of the macroblocks of the current layer are of the field type and the corresponding pair of the macroblocks of the lower layer are of the frame type; and a prediction decoding unit which decodes the macroblock of the current layer using the set reference index.

According to another aspect of the present invention, there is provided an apparatus for encoding a multi-layer interlaced video signal including macroblocks that were coded in an interlaced manner. The apparatus includes a field/frame conversion unit which determines whether a pair of macroblocks of a current layer are of a field type and a corresponding pair of macroblocks of a lower layer are of a frame type, and enlarges a pixel of a top block in a first field of a macroblock of the current layer by setting the enlarged pixel as a pixel value of a bottom block in the field of the macroblock, if the pair of the macroblocks of the current layer are of the field type, and the corresponding pair of the macroblock of the lower layer are of the frame type; a prediction encoding unit which encodes the macroblock of the current layer with reference to the set pixel value.

According to another aspect of the present invention, there is provided an apparatus for decoding a multi-layer interlaced video signal including macroblocks that were coded in an interlaced manner. The apparatus includes a field/frame conversion unit which determines whether a macroblock of a current layer is of a field type and a corresponding macroblock of a lower layer is of a frame type, and enlarges a pixel of a top block in a first field of a macroblock of the current layer by setting the enlarged pixel as a pixel value of a bottom block in the field of the macroblock, if the macroblock of the current layer is of the field type and the corresponding macroblock of the lower layer is of the frame type; and a prediction decoding unit which decodes the macroblock of the current layer with reference to the set pixel value.

### BRIEF DESCRIPTION OF THE DRAWINGS

The above and other aspects of the present invention will become more apparent by describing in detail preferred embodiments thereof with reference to the attached drawings, in which:

FIG. 1 is a diagram comparing a related art progressive frame with interlaced fields;

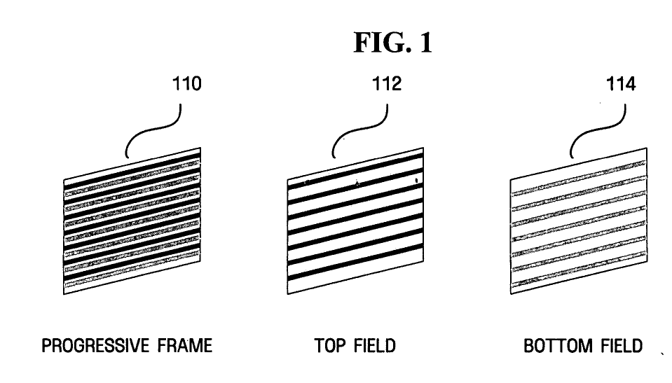

FIG. 2 is a diagram illustrating two cases where a macroblock of a current layer is of a frame type and that of a base layer, which is lower than the current layer, is of a field type;

FIG. 3 is a diagram illustrating a process of interpolating a macroblock of a base layer according to an exemplary embodiment of the present invention;

FIG. 4 is a diagram illustrating a reference index setting according to an exemplary embodiment of the present invention;

FIG. 5 is a diagram illustrating a motion vector setting according to another exemplary embodiment of the present invention;

FIG. 6 is a diagram illustrating a process of analogizing a top field and a bottom field using a macroblock frame according to an exemplary embodiment of the present invention;

FIG. 7 is a diagram illustrating a process of predicting a field macroblock of a current layer using an intra macroblock of a base layer according to an exemplary embodiment of the present invention;

FIG. 8 is a flowchart illustrating an encoding process according to an exemplary embodiment of the present invention;

FIG. 9 is a block diagram of an enhancement layer encoding unit encoding an enhancement layer, the encoding unit being included in a video encoder, according to an exemplary embodiment of the present invention; and

FIG. 10 is a block diagram of an enhancement layer decoding unit decoding an enhancement layer, the decoding unit being included in a video decoder, according to an exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown. The invention may, however, be embodied in many different forms and should not be construed as being limited to the exemplary embodiments set forth herein; rather, these exemplary embodiments are provided so that this disclosure will be thorough and complete, and will fully convey the concept of the invention to those skilled in the art. Like reference numerals in the drawings denote like elements, and thus their description will be omitted.

Hereinafter, a method and apparatus for encoding/decoding an interlaced video signal using different types of information of a lower layer according to embodiments of the present invention will be described with reference to block diagrams or flowchart illustrations. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

When interlaced field scanning is applied to video coding such as H.264, one of three coding methods may be selected in the case of frame encoding—that is, a method of combining two fields into a frame and coding the frame (a frame mode), a method of coding each of two fields without combining the two fields (field coding), and a method of combining and compressing two fields into a frame, and, for coding, dividing a pair of vertically adjacent macroblocks into the two fields and coding the two fields.

If a frame includes a motion region mixed with a motionless region, it may be efficient to code the motionless region in the frame mode and the motion region in the field mode. In other words, the frame/field encoding determination may be made independently for each vertical pair of macroblocks in a frame. Such a coding option is called macroblock-adaptive frame/field (MBAFF) coding. In order for a pair of macroblocks to be coded in the frame mode, each macroblock in the pair has to include a frame line. In addition, in order for the pair of macroblocks to be coded in the field mode, a top macroblock in the pair includes a top field line, and a bottom macroblock includes a bottom field line.

When a base layer is referred to in a multi-layer structure, various combinations may be made due to the differences between macroblocks of the base layer and a current layer. Table 1 shows examples of these combinations.

Referring to Table 1, a macroblock type of the current layer may be a frame type and that of the base layer may be a field type. In addition, a pair of macroblocks (a top macroblock and a bottom macroblock) in the base layer may have been coded differently. That is, one of the macroblocks in the pair may have been intra-coded, and the other one may have been inter-coded. In this case, inter-layer prediction cannot be performed because a top line of the current layer has to be predicted using the intra-coded macroblock of the base layer and a bottom line of the current layer has to be predicted using the inter-coded macroblock of the base layer.

TABLE 1

| | | | | |
|---|---|---|---|---|
| Macroblock Type of Current Layer | Field | Field | Frame | Frame |
| Macroblock Type of Base layer | Frame | Frame | Field | Field |
| Prediction Mode of Top | Inter | Intra | Inter | Intra |
| Macroblock | | | | |
| Prediction Mode of Bottom | Intra | Inter | Intra | Inter |
| Macroblock | | | | |

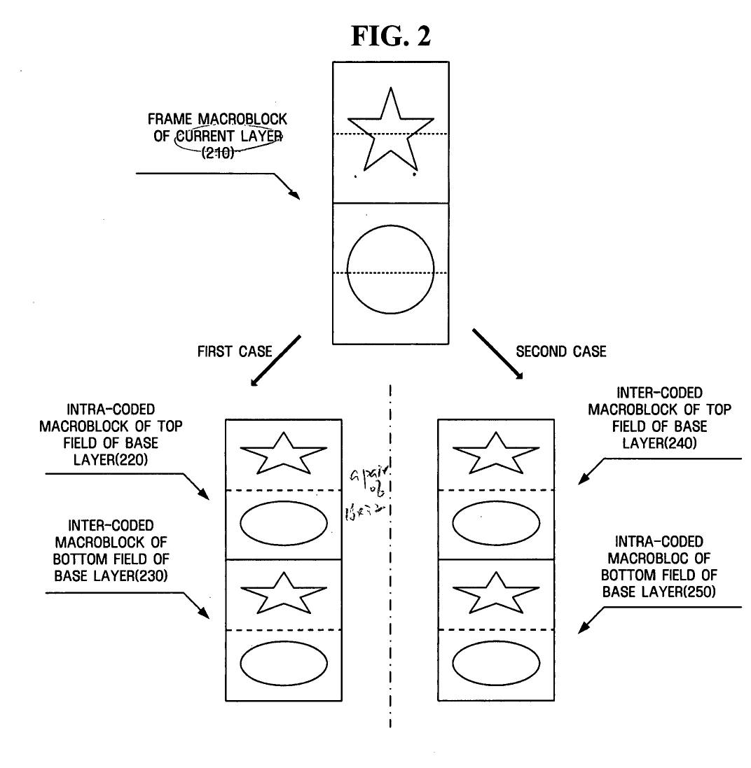

FIG. 2 is a diagram illustrating two cases where a macroblock 210 of a current layer is of a frame type and that of a base layer, which is lower than the current layer, is of a field type. In a first case, a top field of the base layer is an intra-coded macroblock 220, and a bottom field is an inter-coded macroblock 230. In a second case, the top field of the base layer is an inter-coded macroblock 240, and the bottom field is an intra-coded macroblock 250.

In the two cases illustrated in FIG. 2, an exemplary embodiment of the present invention suggests interpolation as a method of predicting the current layer. A 16×16 top macroblock of the base layer is generated into a pair of 16×32 intra-coded macroblocks using an interpolation filter. The 16×32 intra-coded macroblocks thus interpolated are referred to by a 16×32 macroblock of the current layer. The 16×32 macroblock of the current layer may use an intra base layer (BL) method.

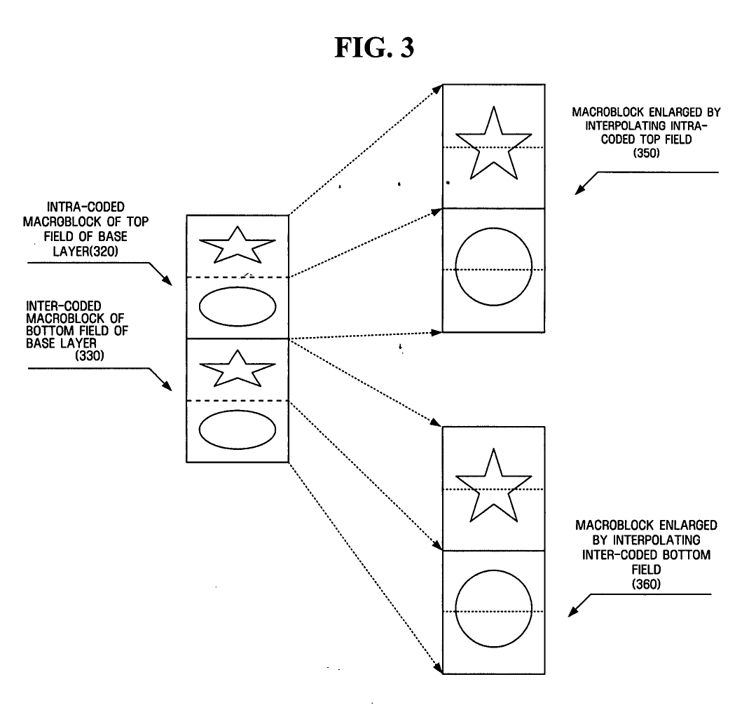

FIG. 3 is a diagram illustrating a process of interpolating a macroblock of a base layer according to an exemplary embodiment of the present invention. In FIG. 3, a process of interpolating the intra- and inter-coded macroblocks 220 and 230 of the base layer of FIG. 2 is illustrated.

Referring to FIG. 3, an intra-coded macroblock 320 of a top field in the base layer is interpolated and enlarged into an intra-coded macroblock 350, and an inter-coded macroblock 330 of a bottom field in the base layer is interpolated and enlarged into an inter-coded macroblock 360. In an example of a method of interpolating a top field, an empty space between a macroblock of a top field and that of a next top field may be interpolated.

If an interpolation filter is set to an inter-coded macroblock of the bottom field in the base layer, a 16×16 macroblock of the top field in the base layer is interpolated into a pair of 16×32 inter-coded macroblocks. The 16×32 inter-coded macroblocks are referred to for residual prediction. If an interpolated macroblock of the base layer is an inter-coded macroblock, a motion vector can be calculated from the base layer by multiplying each 4×4 sub-block by two (2). Macroblock partitioning may be derived from the base layer.

A frame macroblock of a current layer may select a prediction mode. In other words, inter-prediction and directional intra prediction may be performed using rate distortion (RD) calculation.

An interpolation method which can be used for prediction when the macroblock type of the current layer is the frame type and that of the base layer is the field type has been described above with reference to FIGS. 2 and 3.

Hereinafter, a case where the macroblock type of the current layer is the field type and that of the base layer is the frame type will be described.

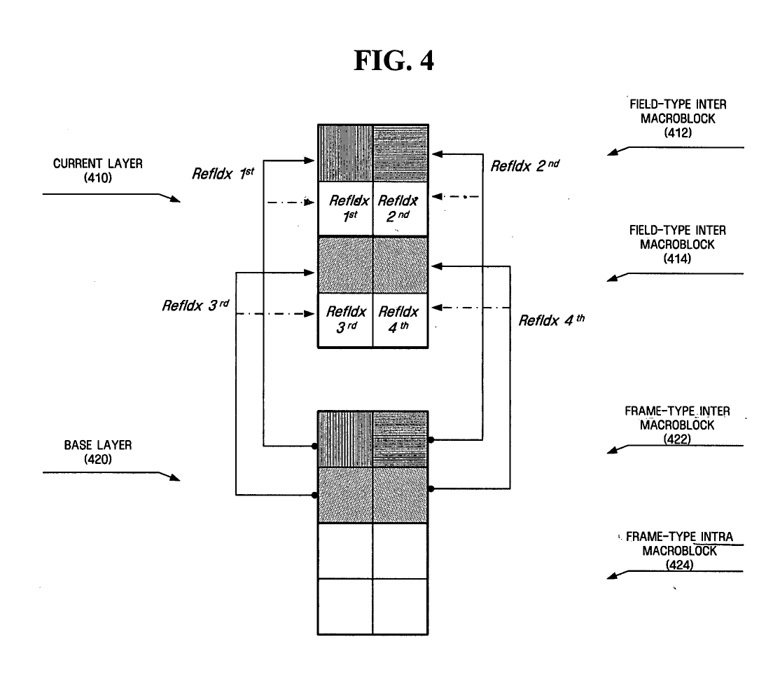

Specifically, performing the inter-layer prediction of a reference index and a motion vector when a pair of macroblocks in the base layer are frame-type inter and intra macroblocks, respectively, will now be described. FIG. 4 is a diagram illustrating a reference index setting according to an exemplary embodiment of the present invention. As illustrated in FIG. 4, reference indices are set. When a frame-type inter macroblock 422 and a frame-type intra macroblock 424 of a base layer 420 are used for macroblock prediction of a current layer 410, a field-type inter macroblock 412 of the current layer 410 refers to sub-blocks in an upper part of the frame-type inter macroblock 422 in the base layer 420. Similarly, a field-type inter macroblock 414 of the current layer 410 refers to sub-blocks in a lower part of the frame-type inter macroblock 422 of the base layer 420.

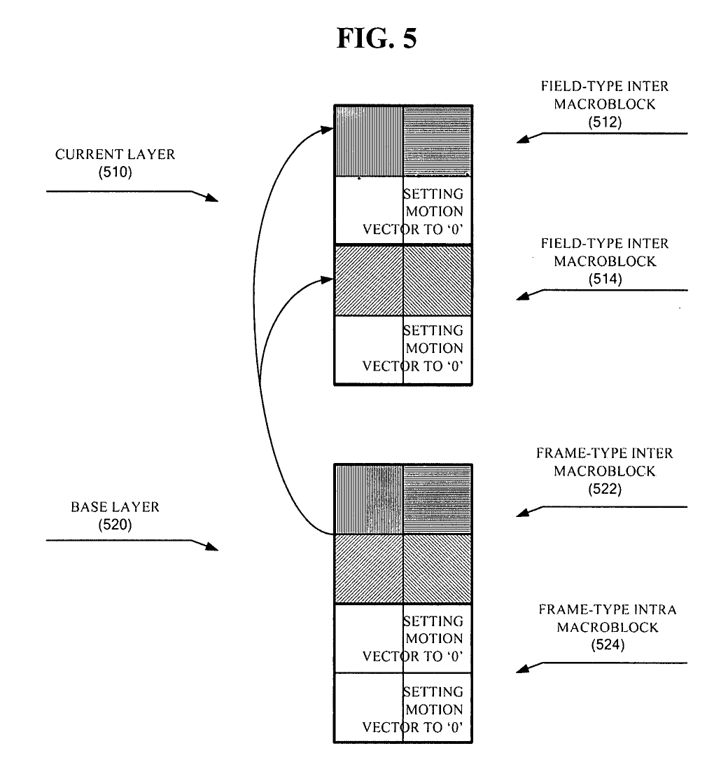

FIG. 5 is a diagram illustrating a motion vector setting according to another exemplary embodiment of the present invention.

Referring to FIG. 5, a motion vector is set to ‘zero’ in each of a field-type inter macroblock 512 in a top field of a current layer 510 and a field-type inter macroblock 514 in a bottom field of the current layer 510. The reason why a motion vector of a 4×4 macroblock of the current layer 510 is set to zero is that a motion vector of a frame-type intra macroblock 524 of a base layer 520 is set to zero.

In the case of inter-layer residual and texture prediction of a macroblock, a pair of macroblocks in a current layer may be a pair of field macroblocks and a corresponding pair of macroblocks in a base layer may be a pair of frame macroblocks, or the other way around. In addition, one of the macroblocks in the pair of the base layer may have been coded in an intra-prediction mode, and the other one in the pair may have been coded in an inter-prediction mode. In this case, base_mode_flag is set to zero, intra_base_flag may be set to zero in a single loop decoding mode, and residual_prediction_flag may also be set to zero. In inter-layer motion prediction, a pair of macroblocks of the current layer may be a pair of frame macroblocks and a corresponding pair of macroblocks of the base layer may be a pair of field macroblocks. In addition, one of the macroblocks in the pair of the base layer may have been coded in the intra-prediction mode, and the other one in the pair may have been coded in the inter prediction mode. In this case, base_mode_flag may be set to zero for a macroblock of the current layer.

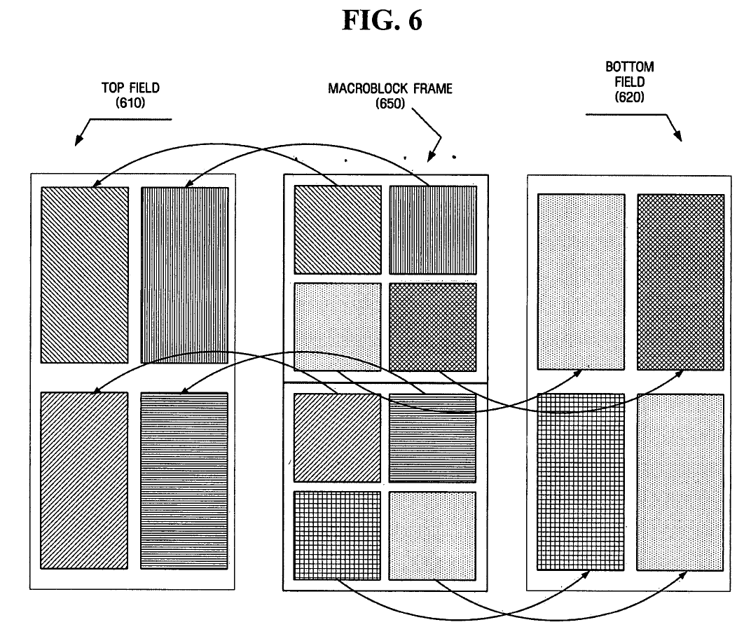

FIG. 6 is a diagram illustrating a process of analogizing a top field 610 and a bottom field 620 using a macroblock frame 650 according to an exemplary embodiment of the present invention. Here, FIGS. 4 and 5 may be referred to in addition to FIG. 6. This analogizing process may be performed in various cases including the following examples.

1) If a macroblock of a current layer is the top field 610 and a corresponding macroblock has been inter-coded, that is, a corresponding pair of macroblocks of a base layer have been inter-coded, reference indices for first and second 8×8 macroblock partitions of the top field 610 may be set to twice the reference indices for first and second 8×8 macroblock partitions of a top macroblock in a corresponding pair of macroblocks of the base layer. In addition, reference indices for third and fourth 8×8 macroblock partitions may be set to twice the reference indices for first and second 8×8 macroblock partitions of a bottom macroblock in the corresponding pair of the base layer.

2) If the macroblock of the current layer is the top field 610 and a corresponding macroblock has been intra-coded, the reference indices for the first and third 8×8 macroblock partitions of the top field 610 may be set to twice the reference index for the first 8×8 macroblock partition of the bottom macroblock in the corresponding pair of the base layer. In addition, the reference indices for second and fourth 8×8 macroblock partitions may be set to twice the reference index for the second 8×8 macroblock partition of the bottom macroblock in the corresponding pair of the base layer.

3) If the macroblock of the current layer is the top field 610 and the bottom macroblock in the corresponding pair of macroblocks of the base layer has been intra-coded, the reference indices for the first and third 8×8 macroblock partitions of the top field 610 may be set to twice the reference index for the first 8×8 macroblock partition of the top macroblock in the corresponding pair of the base layer. In addition, the reference indices for the second and fourth 8×8 macroblock partitions may be set to twice the reference index for the second 8×8 macroblock partition of the top macroblock in the corresponding pair of the base layer.

4) If the macroblock of the current layer is the bottom field 620 and a corresponding pair of top macroblocks have been intra-coded, reference indices for first and third 8×8 macroblock partitions of the bottom field 620 may be set to twice the reference index for the third 8×8 macroblock partition of the bottom macroblock in the corresponding pair of the base layer. In addition, reference indices for second and fourth 8×8 macroblock partitions may be set to twice the reference index for the fourth 8×8 macroblock partition of the bottom macroblock in the corresponding pair of the base layer.

5) If the macroblock of the current layer is the bottom field 620 and the corresponding pair of top macroblocks have been intra-coded, the reference indices for the first and third 8×8 macroblock partitions of the bottom field 620 may be set to twice the reference index for the third 8×8 macroblock partition of the top macroblock in the corresponding pair of the base layer. In addition, the reference indices for the second and fourth 8×8 macroblock partitions may be set to twice the reference index for the fourth 8×8 macroblock partition of the top macroblock in the corresponding pair of the base layer.

6) If the macroblock of the current layer is the bottom field 620 and the corresponding pair of top macroblocks have been inter-coded, the reference indices for the first and second 8×8 macroblock partitions of the bottom field 620 may be set to twice the reference indices for the third and fourth 8×8 macroblock partitions of the top macroblock in the corresponding pair of the base layer. In addition, the reference indices for the third and fourth 8×8 macroblock partitions may be set to twice the reference indices for the third and fourth 8×8 macroblock partitions of the bottom macroblock in the corresponding pair of the base layer.

The following equations may be used in order to calculate a motion vector. If a macroblock of a current layer is a field macroblock and that of a base layer is a frame macroblock, the following equations may be applied. Before calculating a motion vector, elements of the equations will be described. LX indicates a list index in (0, 1), and x and y, which have values between 0 and 3, respectively indicate horizontal and vertical positions of a 4×4 block in a current macroblock. In addition, Curr and BL respectively indicate a pair of macroblocks of the current layer and a corresponding pair of macroblocks of the base layer.

FrameToField (mv) returns a motion vector mv* which satisfies the following characteristics. If a horizontal element is input to a motion vector, mv*[0]=mv[0]. If a motion vector to which a vertical element is input is divided by two, mv[1]=mv[1]/2.

1) A motion vector of first and third rows of a 4×4 block in a top macroblock and that of second and fourth rows of a 4×4 block in a bottom macroblock are calculated as follows.

[Equation 1]

If a top frame is an inter frame:
MV_{TopField}(LX, x, 0, Curr)=FrameToField(MV_{TopFrame}(LX, x, 0, BL))

If a top frame is an intra frame: MV_{TopField}(LX, x, 0, Curr)=0.

[Equation 2]

If a bottom frame is an inter frame:
MV_{TopField}(LX, x, 2, Curr)=FrameToField(MV_{BotomFrame}(LX, x, 0, BL))

If the bottom frame is an intra frame: MV_{TopField}(LX, x, 2, Curr)=0.

[Equation 3]

If a top frame is an inter frame:
MV_{BottomField}(LX, x, 1, Curr)=FrameToField(MV_{TopFrame}(LX, x, 3, BL))

If the top frame is an intra frame: MV_{BottomField}(LX, x, 1, Curr)=0.

[Equation 4]

If a bottom frame is an inter frame:
MV_{BottomField}(LX, x, 3, Curr)=FrameToField(MV_{BottomFrame}(LX, x, 3, BL))

If the bottom frame is an intra frame: MV_{BottomField}(LX, x, 3, Curr)=0.

In Equations 1 through 4, x may have a value of 0, 1, 2, or 3.

2) If reference picture indices for first and third 8×8 macroblock partitions in a top macroblock of the base layer are identical, the following equations may be applied.

[Equation 5]

If a top frame is an inter frame:
MV_{TopField}(LX, x, 1, Curr)=FrameToField(MV_{TopFrame}(LX, x, 2, BL))

If the top frame is an intra frame: MV_{TopField}(LX, x, 1, Curr)=0.

[Equation 6]

If a top frame is an inter frame:
MV_{BottomField}(LX, x, 0, Curr)=FrameToField(MV_{TopFrame}(LX, x, 1, BL))

If the top frame is an intra frame: MV_{BottomField}(LX, x, 0, Curr)=0.

In Equations 5 and 6, x may have a value of 0 or 1. If the reference picture indices for the first and third 8×8 macroblock partitions in the top macroblock of the base layer are not identical, Equations 7 and 8 may be applied.

[Equation 7]

If a top frame is an inter frame:
MV_{TopField}(LX, x, 1, Curr)=FrameToField(MV_{TopFrame}(LX, x, 1, BL))

If the top frame is an intra frame: MV_{TopField}(LX, x, 1, Curr)=0.

[Equation 8]

If a top frame is an inter frame:
MV_{BottomField}(LX, x, 0, Curr)=FrameToField(MV_{TopFrame}(LX, x, 2, BL))

If the top frame is an intra frame: MV_{BottomField}(LX, x, 0, Curr)=0.

In Equations 7 and 8, x may have values of 0 and 1.

Similarly, if reference picture indices of second and fourth 8×8 macroblock partitions of the top macroblock of the base layer are identical, x=2 or 3 may be applied to Equations 5 and 6. In other cases, x=2 or 3 may be applied to Equations 7 and 8.

3) If reference picture indices of first and third 8×8 macroblock partitions of a bottom macroblock of the base layer are identical, the following equations may be applied.

[Equation 9]

If a bottom frame is an inter frame:
MV_{TopField}(LX, x, 3, Curr)=FrameToField(MV_{BotomFrame}(LX, x, 2, BL))

If the bottom frame is an intra frame: MV_{TopField}(LX, x, 3, Curr)=0.

[Equation 10]

If a bottom frame is an inter frame:
MV_{BottomField}(LX, x, 2, Curr)=FrameToField(MV_{TopFrame}(LX, x, 2, BL))

If the bottom frame is an intra frame: MV_{BottomField}(LX, x, 2, Curr)=0.

In Equations 9 and 10, x may have values of 0 or 1.

If the reference picture indices of the first and third 8×8 macroblock partitions of the bottom macroblock of the base layer are not identical, Equations 11 and 12 may be applied.

[Equation 11]

If a bottom frame is an inter frame:
MV_{TopField}(LX, x, 3, Curr)=FrameToField(MV_{BottomFrame}(LX, x, 1, BL))

If the bottom frame is an intra frame: MV_{TopField}(LX, x, 3, Curr)=0.

[Equation 12]

If a bottom frame is an inter frame:
MV_{BottomField}(LX, x, 2, Curr)=FrameToField(MV_{TopFrame}(LX, x, 2, BL))

If the bottom frame is an intra frame: MV_{BottomField}(LX, x, 2, Curr)=0.

In Equations 11 and 12, x may have values of 0 or 1.

Similarly, if reference picture indices of second and fourth 8×8 macroblock partitions of a top macroblock of the base layer are identical, x=2 or 3 may be applied to Equations 9 and 10. In other cases, x=2 or 3 may be applied to Equations 11 and 12.

4) If a macroblock of the current layer is a frame macroblock and a macroblock of the base layer is a field macroblock, the following equations may be applied. In the following equations, LX indicates a list index in (0, 1), and x and y, which have values between 0 and 3, respectively indicate horizontal and vertical positions of a 4×4 block in a current macroblock. In addition, Curr and BL respectively indicate a pair of macroblocks of the current layer and a corresponding pair of macroblocks of the base layer.

FrameToField (mv) returns a motion vector mv* which satisfies the following characteristics. If a horizontal element is input to a motion vector, mv*[0]=mv[0]. If a motion vector to which a vertical element is input is divided by two (2), mv*[1]=mv[1]/2.

In Equations 13 and 14, y may have a value of 0 or 1, and x may have a value of 0, 1, 2 or 3.

[Equation 13]
MV_{TopFrame}(LX, x, y, Curr)=FieldToFrame(MV_{TopField}(LX, x, y, BL))

[Equation 14]
MV_{BottomFrame}(LX, x, y, Curr)=FieldToFrame(MV_{TopField}(LX, x, y+2, BL))

In Equations 15 and 16, y may have a value of 2 or 3, and x may have a value of 0, 1, 2 or 3.

[Equation 15]
MV_{TopFrame}(LX, x, y, Curr)=FieldToFrame(MV_{BottomField}(LX, x, y−2, BL))

[Equation 16]
MV_{BottomFrame}(LX, x, y, Curr)=FieldToFrame(MV_{BottomField}(LX, x, y, BL))

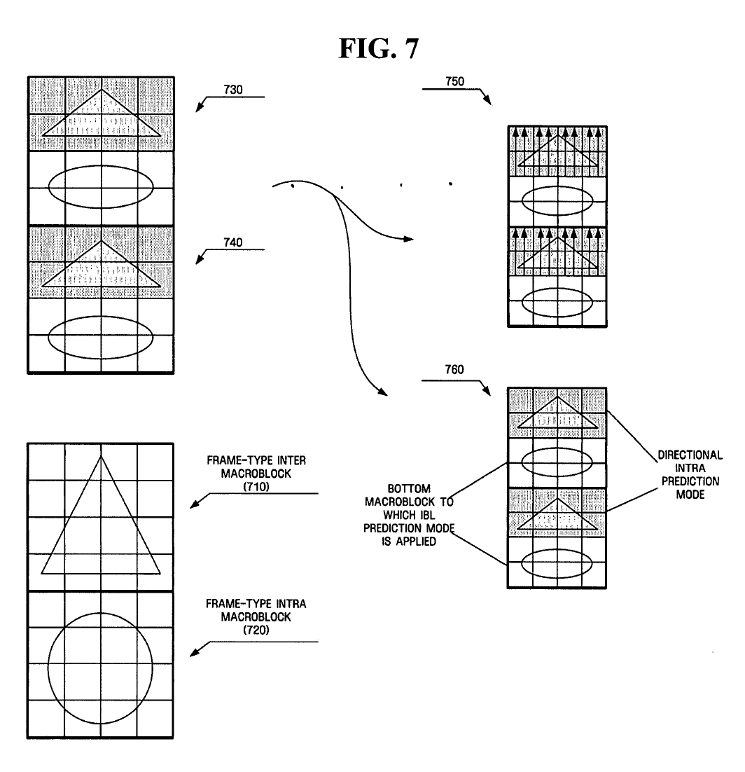

FIG. 7 is a diagram illustrating a process of predicting a field macroblock of a current layer using an intra macroblock of a base layer according to an exemplary embodiment of the present invention. The field macroblock of the current layer can be predicted using the intra macroblock of the base layer. In FIG. 7, a bottom macroblock of each field of the current layer uses an intra base layer (IBL) prediction mode in which a frame-type intra macroblock of the base layer is used. In this case, a top macroblock of each field of the current layer cannot have an appropriate predictor. Therefore, the following methods may be applied in order to obtain an appropriate predictor for the top macroblocks (regions 730 and 740) filled with dots as shown in FIG. 7.

1) The regions 730 and 740 may be filled with a pixel value of 128.

2) Each of the regions 730 and 740 may be enlarged and filled with top pixel values of each of bottom macroblocks as shown in macroblocks 750 illustrated in FIG. 7.

3) One of directional intra modes in the IBL prediction mode may be replaced. After it is checked whether one of the directional intra modes is used, a current mode may be changed to the IBL mode. Although a current 16×16 field macroblock uses the directional intra mode, a current field block corresponding to the texture of the base layer requires the base layer's texture information having the directional intra mode. A block which does not correspond to the texture of the base layer uses a previous direction.

4) A 16×16 macroblock may have both the IBL flag and directional intra information. The regions 730 and 740 of FIG. 7 are set to a previous directional intra mode, and corresponding bottom macroblocks may be predicted using the IBL prediction mode as shown in a macroblock 760 of FIG. 7.

In FIG. 7, residual prediction is performed on the top macroblocks of the current layer using the frame-type inter macroblock of the base layer. The bottom macroblocks of the current layer cannot have a residual in the base layer. In this case, if a corresponding macroblock of the base layer is an intra macroblock, a value of 0 may be allocated.

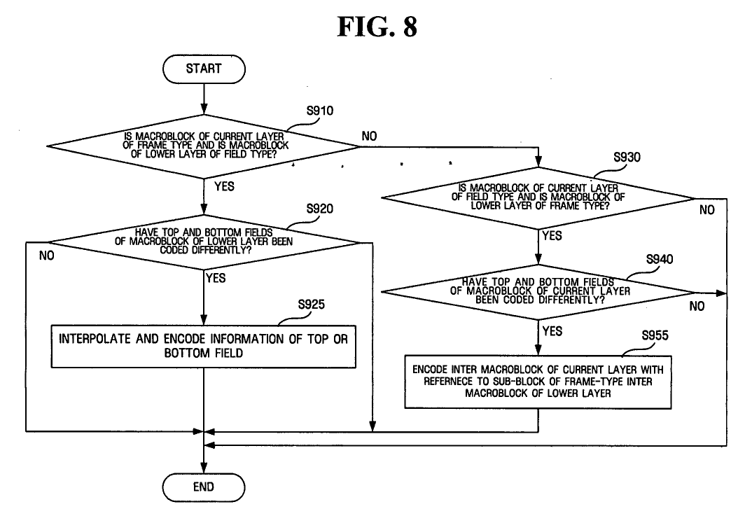

FIG. 8 is a flowchart illustrating an encoding process according to an exemplary embodiment of the present invention.

Referring to FIG. 8, it is determined whether a macroblock of a current layer is a frame macroblock and that of a lower layer is a field macroblock (operation S910). If it is determined that the macroblock of the current layer is the frame macroblock and that of the lower layer is the field macroblock, it is also determined whether top and bottom fields of the macroblock of the lower layer have been coded differently (operation S920). If it is determined that the top and bottom fields have been coded differently, information of the top or bottom field is interpolated and encoded as illustrated in FIG. 2 (operation S925).

The lower layer may be a base layer described above, or may be a layer lower than the current layer or a fine granular scalability (FGS) layer in the case of a multi-layer structure.

If it is determined in operation S910 that the macroblock of the current layer is not the frame macroblock and the macroblock of the lower layer is not the field macroblock, it is also determined whether the macroblock of the current layer is the field macroblock and that of the lower layer is the frame macroblock (operation S930). If it is determined that the macroblock of the current layer is the field macroblock and that of the lower layer is the frame macroblock, it is also determined whether top and bottom fields of the macroblock of the current layer have been coded differently (operation S940). Then, an inter macroblock of the current layer is encoded with reference to a sub-block of a frame-type inter macroblock of the lower layer (operation S955).

The above process is a process of encoding the current layer using the base layer or the lower layer. Decoding may be performed in a similar process to the above process. Before a decoding end decodes the current layer, it interpolates or refers to data of the lower layer, which may be determined as illustrated in FIG. 8.

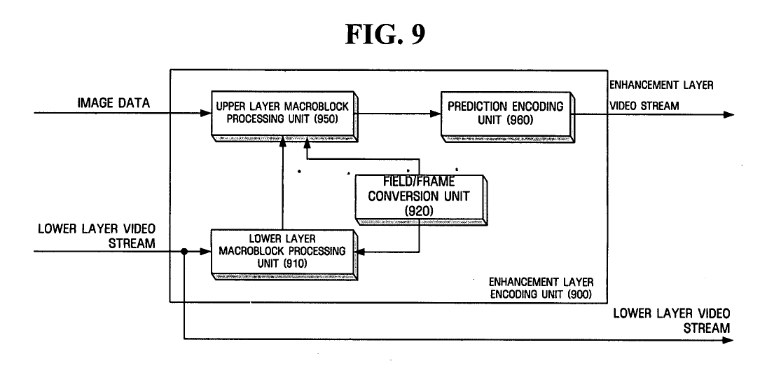

FIG. 9 is a block diagram of an encoding unit according to an exemplary embodiment of the present invention.

Each component means, but is not limited to, a software or hardware component, such as a Field Programmable Gate Array (FPGA) or Application Specific Integrated Circuit (ASIC). A component may advantageously be configured to reside on the addressable storage medium and configured to execute on one or more processors. The functionality provided for in the components may be combined into fewer components or further separated into additional components. In addition, the components may be implemented to execute one or more computers in a system.

Specifically, FIG. 9 is a block diagram of an enhancement layer encoding unit 900 encoding an enhancement layer, the encoding unit 900 being included in a video encoder, according to an exemplary embodiment of the present invention. Since a quantization process included in a process of encoding a base layer or a video signal is a conventional art, a detailed description thereof will be omitted in this disclosure. The enhancement layer encoding unit 900 encodes a video signal of a layer, i.e., a current layer, which may refer to another lower layer such as a base layer or an FGS layer.

The enhancement layer encoding unit 900 generates prediction data for encoding a macroblock of an upper layer (current layer) using a field/frame conversion unit 920 and an upper layer macroblock processing unit 950. Then, a prediction encoding unit 960 encodes the macroblock of the upper layer using the generated prediction data.

If the macroblock type of any one of the current layer and the lower layer (base layer) is a field type and the other one is a frame type, the field/frame conversion unit 920 performs interpolation, region expansion, or twice enlargement using information of a lower layer macroblock processing unit 910 so that the current layer can refer to data of the lower layer.

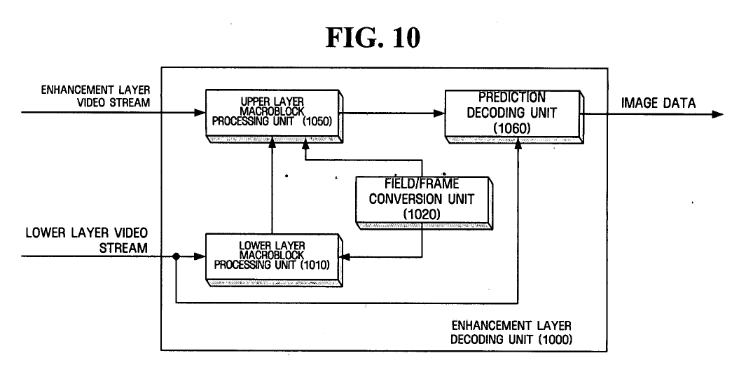

FIG. 10 is a block diagram of an enhancement layer decoding unit 1000 decoding an enhancement layer, the decoding unit 1000 being included in a video decoder, according to an exemplary embodiment of the present invention. Since an inverse quantization process included in a process of decoding a base layer or a video signal is a conventional art, a detailed description thereof will be omitted in this disclosure.

The enhancement layer decoding unit 1000 of FIG. 10 has a similar structure to that of the enhancement layer encoding unit 900 of FIG. 9. In order to decode an enhancement-layer video stream, it is required to restore a macroblock of the lower layer that is to be referred to. Therefore, if the macroblock type of any one of the current layer and the lower layer (base layer) is the field type and the other one is the frame type, a field/frame conversion unit 1020 performs interpolation, region expansion, or twice enlargement using information of a lower layer macroblock processing unit 1010 so that the current layer can refer to data of the lower layer.

According to the exemplary embodiments of the present invention, data of a lower layer can be referred to even when current and lower layers have different macroblock types (frame and field types).

According to the exemplary embodiments of the present invention, encoding efficiency can be enhanced by referring to the data of the lower layer.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the following claims, and all differences within the scope will be construed as being included in the present invention.

What is claimed is:

1. A method of encoding a multi-layer interlaced video signal having macroblocks that were coded in an interlaced manner, the method comprising:
determining whether a pair of macroblocks of a current layer are of a frame type and a corresponding pair of macroblocks of a lower layer are of a field type, and determining whether top and bottom fields of the corresponding pair of the macroblocks of the lower layer have been coded in different prediction modes; and
predicting and encoding a macroblock of the current layer by interpolating information of the top or bottom field of a corresponding macroblock of the lower layer, if the pair of the macroblocks of the current layer are of the frame type and the corresponding pair of macroblocks of the lower layer are of the field type, and the top and bottom fields of the corresponding pair of the macroblocks of the lower layer have been coded in different prediction modes.

2. The method of claim 1, wherein a prediction mode for the top field of the corresponding pair of the macroblocks of the lower layer is an inter-prediction mode and a prediction mode for the bottom field of the corresponding pair of the macroblocks of the lower layer is an intra-prediction mode, or the prediction mode for the top field of the corresponding pair of the macroblocks of the lower layer is the intra-prediction mode and the prediction mode for the bottom field of the corresponding pair of the macroblocks of the lower layer is the inter-prediction mode.

3. The method of claim 1, wherein the predicting and encoding of the macroblock of the current layer further comprises interpolating and calculating information of a pixel that exists between adjacent pixels in an inter-coded macroblock or an intra-coded macroblock of the lower layer.

4. The method of claim 1, further comprising calculating a motion vector by multiplying a 4×4 sub-block of the interpolated lower layer by two before the predicting and encoding of the macroblock of the current layer.

5. A method of decoding a multi-layer interlaced video signal having macroblocks that were coded in an interlaced manner, the method comprising:
determining whether a pair of macroblocks of a current layer are of a frame type and a corresponding pair of macroblocks of a lower layer are of a field type, and determining whether top and bottom fields of the corresponding pair of the macroblocks of the lower layer have been coded in different prediction modes; and
predicting and decoding the macroblock of the current layer by interpolating information of the top or bottom field of a corresponding macroblock of the lower layer, if the pair of the macroblocks of the current layer are of the frame type and the corresponding pair of macroblocks of the lower layer are of the field type, and the top and bottom fields of the corresponding pair of the macroblocks of the lower layer have been coded in different prediction modes.

6. The method of claim 5, wherein a prediction mode for the top field of the corresponding pair of the macroblocks of the lower layer is an inter-prediction mode and a prediction mode for the bottom field of the corresponding pair of the macroblocks of the lower layer is an intra-prediction mode, or the prediction mode for the top field of the corresponding pair of the macroblocks of the lower layer is the intra-prediction mode and the prediction mode for the bottom field of the corresponding pair of the macroblocks of the lower layer is the inter-prediction mode.

7. The method of claim 5, wherein the predicting and decoding of the macroblock of the current layer further comprises interpolating and calculating information of a pixel that exists between adjacent pixels in an inter-coded macroblock or an intra-coded macroblock of the lower layer.

8. The method of claim 5, further comprising calculating a motion vector by multiplying a 4×4 sub-block of the interpolated lower layer by two before the predicting and decoding of the macroblock of the current layer.

9. A method of encoding a multi-layer interlaced video signal having macroblocks that were coded in an interlaced manner, the method comprising:
determining whether a pair of macroblocks of a current layer are of a field type and a corresponding pair of macroblocks of a lower layer are of a frame type, and determining whether top and bottom macroblocks constituting the corresponding pair of the macroblocks of the lower layer have been coded in different prediction modes; and
encoding an inter macroblock of the current layer with reference to a sub-block of a frame-type inter macroblock of the lower layer, if the pair of the macroblocks of the current layer are of the field type and the corresponding pair of the macroblocks of the lower layer are of the frame type, and the top and bottom macroblocks constituting the corresponding pair of the macroblocks of the lower layer have been coded in different prediction modes.

10. The method of claim 9, wherein both the sub-block of the frame-type inter macroblock of the lower layer and the inter macroblock of the current layer are placed at an upper position or a lower position.

11. The method of claim 9, wherein a motion vector of the inter-macroblock of the current layer is set to zero.

12. A method of decoding a multi-layer interlaced video signal having macroblocks that were coded in an interlaced manner, the method comprising:
determining whether a pair of macroblocks of a current layer are of a field type and a corresponding pair of macroblocks of a lower layer are of a frame type, and determining whether top and bottom macroblocks constituting the corresponding pair of the macroblocks of the lower layer have been coded in different prediction modes; and
decoding an inter macroblock of the current layer with reference to a sub-block of a frame-type inter macroblock of the lower layer, if the pair of the macroblocks of the current layer are of the field type and the corresponding pair of the macroblocks of the lower layer are of the frame type, and the top and bottom macroblocks constituting the corresponding pair of the macroblocks of the lower layer have been coded in different prediction modes.

13. The method of claim 12, wherein both the sub-block of the frame-type inter macroblock of the lower layer and the inter macroblock of the current layer are placed at an upper position or a lower position.

14. The method of claim 12, wherein a motion vector of the inter-macroblock of the current layer is set to zero.

15. A method of encoding a multi-layer interlaced video signal having macroblocks that were coded in an interlaced manner, the method comprising:
determining whether a pair of macroblocks of a current layer are of a field type and a corresponding pair of macroblocks of a lower layer are of a frame type;
setting a reference index of a macroblock of the current layer to twice a reference index of a corresponding macroblock of the lower layer, if the pair of the macroblocks of the current layer are of the field type and the corresponding pair of the macroblocks of the lower layer are of the frame type; and
encoding the macroblock of the current layer using the set reference index.

16. The method of claim 15, wherein the setting of the reference index comprises setting reference indexes of first and second sub-blocks of a top field of the macroblock of the current layer to twice reference indexes of first and second sub-blocks of a top macroblock of the corresponding of macroblock of the lower layer, respectively, if the macroblock of the current layer is the top field.

17. The method of claim 15, wherein the setting of the reference index comprises setting reference indexes of third and fourth sub-blocks of a top field of the macroblock of the current layer to twice reference indexes of first and second sub-blocks of a bottom macroblock of the corresponding macroblock of the lower layer, respectively, if the macroblock of the current layer is the top field.

18. The method of claim 15, wherein the setting of the reference index comprises setting reference indexes of first and second sub-blocks of a bottom field of the macroblock of the current layer to twice reference indexes of third and fourth sub-blocks of a top macroblock of the corresponding macroblock of the lower layer, respectively, if the macroblock of the current layer is the bottom field.

19. The method of claim 15, wherein the setting of the reference index comprises setting reference indexes of third and fourth sub-blocks of a bottom field of the macroblock of the current layer to twice reference indexes of third and fourth sub-blocks of a bottom macroblock of the corresponding macroblock of the lower layer, respectively, if the macroblock of the current layer is the bottom field.

20. A method of decoding a multi-layer interlaced video signal having macroblocks that were coded in an interlaced manner, the method comprising:
determining whether a pair of macroblocks of a current layer are of a field type and a corresponding pair of macroblocks of a lower layer are of a frame type;
setting a reference index of a macroblock of the current layer to twice a reference index of a corresponding macroblock of the lower layer, if the pair of the macroblocks of the current layer are of the field type and the corresponding pair of the macroblocks of the lower layer are of the frame type; and
decoding the macroblock of the current layer using the set reference index.

21. The method of claim 20, wherein the setting of the reference index comprises setting reference indexes of first and second sub-blocks of a top field of the macroblock of the current layer to twice reference indexes of first and second sub-blocks of a top macroblock of the corresponding macroblock of the lower layer, respectively, if the macroblock of the current layer is the top field.

22. The method of claim 21, wherein the setting of the reference index comprises setting reference indexes of third and fourth sub-blocks of a top field of the macroblock of the current layer to twice reference indexes of first and second sub-blocks of a bottom macroblock of the corresponding macroblock of the lower layer, respectively, if the macroblock of the current layer is the top field.

23. The method of claim 21, wherein the setting of the reference index comprises setting reference indexes of first and second sub-blocks of a bottom field of the macroblock of the current layer to twice reference indexes of third and fourth sub-blocks of a top macroblock of the corresponding macroblock of the lower layer, respectively, if the macroblock of the current layer is the bottom field.

24. The method of claim 21, wherein the setting of the reference index comprises setting reference indexes of third and fourth sub-blocks of a bottom field of the macroblock of the current layer to twice reference indexes of third and fourth sub-blocks of a bottom macroblock of the corresponding macroblock of the lower layer, respectively, if the macroblock of the current layer is the bottom field.

25. A method of encoding a multi-layer interlaced video signal having macroblocks that were coded in an interlaced manner, the method comprising:
determining whether a pair of macroblocks of a current layer are of a field type and a corresponding pair of macroblocks of a lower layer are of a frame type; and
enlarging a pixel of a top block in a first field of a macroblock of the current layer by setting the enlarged pixel as a pixel value of a bottom block in the field of the macroblock, and encoding the macroblock of the current layer, if the pair of the macroblocks of the current layer are of the field type, and the corresponding pair of the macroblocks of the lower layer are of the frame type.

26. The method of claim 25, wherein the first field is a top field or a bottom field.

27. The method of claim 25, further comprising changing a directional intra mode to an intra base layer (IBL) mode if the top block in the first field of the macroblock of the current layer uses the directional intra mode.

28. A method of decoding a multi-layer interlaced video signal having macroblocks that were coded in an interlaced manner, the method comprising:
determining whether a pair of macroblocks of a current layer are of a field type and a corresponding pair of macroblocks of a lower layer are of a frame type; and
enlarging a pixel of a top block in a first field of a macroblock in the current layer by setting the enlarged pixel as a pixel value of a bottom block in the field of the macroblock, and decoding the macroblock of the current layer, if the pair of the macroblocks of the current layer are of the field type and the corresponding pair of the macroblock of the lower layer are of the frame type.

29. The method of claim 28, wherein the first field is a top field or a bottom field.

30. The method of claim 28, further comprising changing a directional intra mode to an intra base layer (IBL) mode if the top block in the first field of the macroblock of the current layer uses the directional intra mode.

31. An apparatus for encoding a multi-layer interlaced video signal having macroblocks that were coded in an interlaced manner, the apparatus comprising:
a field/frame conversion unit which determines whether a pair of macroblocks of a current layer are of a frame type and a corresponding pair of macroblocks of a lower layer are of a field type, and determines whether top and bottom fields of the corresponding pair of the macroblocks of the lower layer have been coded in different prediction modes, and which interpolates information of the top or bottom field of a macroblock of the lower layer in order to predict a corresponding macroblock of the current layer, if the pair of the macroblocks of the current layer are of the frame type and the corresponding pair of the macroblocks of the lower layer are of the field type, and the top and bottom fields of the corresponding pair of the macroblocks of the lower layer have been coded in different prediction modes; and
a prediction encoding unit which encodes the corresponding macroblock of the current layer based on a result of the prediction.

32. The apparatus of claim 31, wherein a prediction mode for the top field of the corresponding pair of the macroblocks of the lower layer is an inter-prediction mode and a prediction mode for the bottom field of the corresponding pair of the macroblocks of the lower layer is an intra-prediction mode, or the prediction mode for the top field of the corresponding pair of the macroblocks of the lower layer is the intra-prediction mode and the prediction mode for the bottom field of the corresponding pair of the macroblocks of the lower layer is the inter-prediction mode.

33. The apparatus of claim 31, wherein the field/frame conversion unit interpolates and calculates information of a pixel that exists between adjacent pixels in an inter-coded macroblock or an intra-coded macroblock of the lower layer.

34. The apparatus of claim 31, wherein the field/frame conversion unit calculates a motion vector by multiplying a 4×4 sub-block of the interpolated lower layer by two.

35. An apparatus for decoding a multi-layer interlaced video signal having macroblocks that were coded in an interlaced manner, the apparatus comprising:
a field/frame conversion unit which determines whether a pair of macroblocks of a current layer are of a frame type and a corresponding pair of macroblocks of a lower layer are of a field type, and determines whether top and bottom fields of the corresponding pair of the macroblocks of the lower layer have been coded in different prediction modes, and which interpolates information of the top or bottom field of a macroblock of the lower layer in order to predict a corresponding macroblock of the current layer, if the pair of the macroblocks of the current layer are of the frame type and the corresponding pair of the macroblock of the lower layer are of the field type, and the top and bottom fields of the corresponding pair of the macroblocks of the lower layer have been coded in different prediction modes; and
a prediction decoding unit which decodes the corresponding macroblock of the current layer based on a result of the prediction.

36. The apparatus of claim 35, wherein a prediction mode for the top field of the corresponding pair of the macroblocks of the lower layer is an inter-prediction mode and a prediction mode for the bottom field of the corresponding pair of the macroblocks of the lower layer is an intra-prediction mode, or the prediction mode for the top field of the corresponding pair of the macroblocks of the lower layer is the intra-prediction mode and the prediction mode for the bottom field of the corresponding pair of the macroblocks of the lower layer is the inter-prediction mode.

37. The apparatus of claim 35, wherein the field/frame conversion unit interpolates and calculates information of a pixel that exists between adjacent pixels in an inter-coded macroblock or an intra-coded macroblock of the lower layer.

38. The apparatus of claim 35, wherein the field/frame conversion unit calculates a motion vector by multiplying a 4×4 sub-block of the interpolated lower layer by two.

39. An apparatus for encoding a multi-layer interlaced video signal having macroblocks that were coded in an interlaced manner, the apparatus comprising:
a field/frame conversion unit which determines whether a pair of macroblocks of a current layer are of a frame type and a corresponding pair of macroblocks of a lower layer are of a field type, and determines whether top and bottom macroblocks constituting the corresponding pair of the macroblocks of the lower layer have been coded in different prediction modes, and which refers to a sub-block of a frame-type inter macroblock of the lower layer in order to predict an inter macroblock of the current layer, if the pair of the macroblocks of the current layer are of the field type and the corresponding pair of the macroblocks of the lower layer are of the frame type, and the top and bottom macroblocks constituting the corresponding pair of the macroblocks of the lower layer have been coded in different prediction modes; and
a prediction encoding unit which encodes the inter macroblock of the current layer using a result of the prediction.

40. The apparatus of claim 39, wherein both the sub-block of the frame-type inter macroblock of the lower layer and the inter macroblock of the current layer are placed at an upper position or a lower position.

41. The apparatus of claim 39, wherein a motion vector of the inter-macroblock of the current layer is set to zero.

42. An apparatus for decoding a multi-layer interlaced video signal having macroblocks that were coded in an interlaced manner, the apparatus comprising:
a field/frame conversion unit which determines whether a pair of macroblocks of a current layer are of a frame type and a corresponding pair of macroblocks of a lower layer are of a field type, and determines whether top and bottom macroblocks constituting the corresponding pair of the macroblocks of the lower layer have been coded in different prediction modes, and which refers to a sub-block of a frame-type inter macroblock of the lower layer in order to predict an inter macroblock of the current layer, if the pair of the macroblocks of the current layer are of the field type and the corresponding pair of macroblocks of the lower layer are of the frame type, and the top and bottom macroblocks constituting the corresponding pair of the macroblocks of the lower layer have been coded in different prediction modes; and
a prediction decoding unit which decodes the inter macroblock of the current layer using a result of the prediction.

43. The apparatus of claim 42, wherein both the sub-block of the frame-type inter macroblock of the lower layer and the inter macroblock of the current layer are placed at an upper position or a lower position.

44. The apparatus of claim 42, wherein a motion vector of the inter-macroblock of the current layer is set to zero.

45. An apparatus for encoding a multi-layer interlaced video signal having macroblocks that were coded in an interlaced manner, the apparatus comprising:
a field/frame conversion unit which determines whether a pair of macroblocks of a current layer are of a field type and a corresponding pair of macroblocks of a lower layer are of a frame type, and sets a reference index of a macroblock of the current layer to twice a reference index of a corresponding macroblock of the lower layer, if the pair of the macroblocks of the current layer are of the field type and the corresponding pair of the macroblocks of the lower layer are of the frame type; and
a prediction encoding unit which encodes the macroblock of the current layer using the set reference index.

46. The apparatus of claim 45, wherein the field/frame conversion unit sets reference indexes of first and second sub-blocks of a top field of the macroblock of the current layer to twice reference indexes of first and second sub-blocks of a top macroblock of the corresponding macroblock of the lower layer, respectively, if the macroblock of the current layer is the top field.

47. The apparatus of claim 45, wherein the field/frame conversion unit sets reference indexes of third and fourth sub-blocks of a top field of the macroblock of the current layer to twice reference indexes of first and second sub-blocks of a bottom macroblock of the corresponding macroblock of the lower layer, respectively, if the macroblock of the current layer is the top field.

48. The apparatus of claim 45, wherein the field/frame conversion unit sets reference indexes of first and second sub-blocks of a bottom field of the macroblock of the current layer to twice reference indexes of third and fourth sub-blocks of a top macroblock of the corresponding macroblock of the lower layer, respectively, if the macroblock of the current layer is the bottom field.

49. The apparatus of claim 45, wherein the field/frame conversion unit sets reference indexes of third and fourth sub-blocks of a bottom field of the macroblock of the current layer to twice reference indexes of third and fourth sub-blocks of a bottom macroblock of the corresponding macroblock of the lower layer, respectively, if the macroblock of the current layer is the bottom field.

50. An apparatus for decoding a multi-layer interlaced video signal having macroblocks that were coded in an interlaced manner, the apparatus comprising:
a field/frame conversion unit which determines whether a pair of macroblocks of a current layer are of a field type and a corresponding pair of macroblocks of a lower layer are of a frame type, and sets a reference index of a macroblock of the current layer to twice a reference index of a corresponding macroblock of the lower layer, if the pair of the macroblocks of the current layer are of the field type and the corresponding pair of the macroblocks of the lower layer are of the frame type; and
a prediction decoding unit which decodes the macroblock of the current layer using the set reference index.

51. The apparatus of claim 50, wherein the field/frame conversion unit sets reference indexes of first and second sub-blocks of a top field of the macroblock of the current layer to twice reference indexes of first and second sub-blocks of a top macroblock of the corresponding macroblock of the lower layer, respectively, if the macroblock of the current layer is the top field.

52. The apparatus of claim 51, wherein the field/frame conversion unit sets reference indexes of third and fourth sub-blocks of a top field of the macroblock of the current layer to twice reference indexes of first and second sub-blocks of a bottom macroblock of the corresponding macroblock of the lower layer, respectively, if the macroblock of the current layer is the top field.

53. The apparatus of claim 51, wherein the field/frame conversion unit sets reference indexes of first and second sub-blocks of a bottom field of the macroblock of the current layer to twice reference indexes of third and fourth sub-blocks of a top macroblock of the corresponding macroblock of the lower layer, respectively, if the macroblock of the current layer is the bottom field.

54. The apparatus of claim 51, wherein the field/frame conversion unit sets reference indexes of third and fourth sub-blocks of a bottom field of the macroblock of the current layer to twice reference indexes of third and fourth sub-blocks of a bottom macroblock of the corresponding macroblock of the lower layer, respectively, if the macroblock of the current layer is the bottom field.

55. An apparatus for encoding a multi-layer interlaced video signal having macroblocks that were coded in an interlaced manner, the apparatus comprising:
a field/frame conversion unit which determines whether a pair of macroblocks of a current layer are of a field type and a corresponding pair of macroblocks of a lower layer are of a frame type, and enlarges a pixel of a top block in a first field of a macroblock of the current layer by setting the enlarged pixel as a pixel value of a bottom block in the field of the macroblock, if the pair of the macroblocks of the current layer are of the field type, and the corresponding pair of the macroblock of the lower layer are of the frame type; and
a prediction encoding unit which encodes the macroblock of the current layer with reference to the set pixel value.

56. The apparatus of claim 55, wherein the first field is a top field or a bottom field.

57. The apparatus of claim 55, wherein a directional intra mode is changed to an intra base layer (IBL) mode if the top block in the first field of the macroblock of the current layer uses the directional intra mode.

58. An apparatus for decoding a multi-layer interlaced video signal having macroblocks that were coded in an interlaced manner, the apparatus comprising:
a field/frame conversion unit which determines whether a macroblock of a current layer is of a field type and a corresponding macroblock of a lower layer is of a frame type, and enlarges a pixel of a top block in a first field of a macroblock of the current layer by setting the enlarged pixel as a pixel value of a bottom block in the field of the macroblock, if the macroblock of the current layer is of the field type and the corresponding macroblock of the lower layer is of the frame type;
a prediction decoding unit which decodes the macroblock of the current layer with reference to the set pixel value.

59. The apparatus of claim 58, wherein the first field is a top field or a bottom field.

60. The apparatus of claim 58, wherein a directional intra mode is changed to an intra base layer (IBL) mode if the top block in the first field of the macroblock of the current layer uses the directional intra mode.
